(19) United States
(12) Patent Application Publication
(10) Pub. No.: US 2008/0030599 A1
(43) Pub. Date: Feb. 7, 2008

(54) Templates for guiding user in use of digital camera

(76) Inventors: Donald J. Stavely, Windsor, CO (US); Amy E. Battles, Windsor, CO (US); Sarah Jean Barrios, Fort Collins, CO (US); Kenneth Ross Stockton, Fort Collins, CO (US); Kathy L. Miner, Fort Collins, CO (US)

Correspondence Address: Hewlett-Packard Company;Intellectual Property Administration, P.O. Box 272400, Fort Collins, CO, 80527-2400, US

(21) Appl. No.: 11/906,855

(22) Filed: Oct. 4, 2007

Related U.S. Application Data
(63) Continuation of application No. 10/618,116, filed on Jul. 10, 2003.

(51) Int. Cl. H04N 5/262

(52) U.S. Cl. 348/239; 348/E05.047

(57) ABSTRACT

A collection of image templates in a digital camera guides a user in the taking of pictures. The image templates may have associated sample images that are optionally replaceable, in arbitrary order, by images captured by the user in the digital camera. Textual or audible instructions for capturing user images to replace the sample images may also be provided. A photo album containing images associated with at least one image template in a collection may be generated automatically.

### FIELD OF THE INVENTION

The present invention relates generally to digital cameras and more specifically to digital camera user interfaces.

### BACKGROUND OF THE INVENTION

Amateur photographers are often pressed into service as the “designated photographer” at special events such as holiday celebrations, weddings, graduations, birthday parties, etc. Also, amateur photographers often take pictures while visiting vacation destinations. Unfortunately, the casual photographer lacks the technical and artistic skills to set up and compose professional-looking shots. First, the casual photographer may not be aware of the full set of shots expected at an event such as a wedding. Second, certain kinds of shots pose particular technical difficulties that an amateur photographer may not know how to overcome. For example, a shot of the bride and groom together at a wedding is one of the most difficult shots to expose without blown-out highlights on the wedding gown or blocked shadows on the tuxedo. Similarly, an amateur photographer taking a picture of the Eiffel Tower may not expose or frame the subject as artistically as a professional photographer would.

One approach to guiding the user in the capture of digital images in a digital camera is to provide, in the digital camera, a script that leads the user step by step through the process of taking a series of shots. For example, a script might lead a realtor through the steps of photographing a property to be advertised on a Web site. This approach has some disadvantages, however. First, the instructions are limited to text or possibly audible instructions. Secondly, the shots must be taken in a prescribed order instead of in the order most convenient for the photographer.

It is thus apparent that there is a need in the art for an improved method for guiding a user in the capture of digital images in a digital camera.

### SUMMARY OF THE INVENTION

A method for guiding a user in the capture of digital images in a digital camera is provided. A digital camera and a computer-readable storage medium implementing the method are also provided.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1A is a functional block diagram of a digital camera in accordance with an illustrative embodiment of the invention.

FIG. 1B is a high-level diagram of a memory in the digital camera shown in FIG. 1A in accordance with an illustrative embodiment of the invention.

FIG. 1C is a functional block diagram of the digital camera shown in FIG. 1A in communication with an external device in accordance with an illustrative embodiment of the invention.

FIG. 2 is a conceptual diagram of a collection of image templates in accordance with an illustrative embodiment of the invention.

FIG. 3A is an illustration of a manner of presenting a collection of image templates on a display of the digital camera shown in FIG. 1A in accordance with an illustrative embodiment of the invention.

FIG. 3B is an illustration of another manner of presenting a collection of image templates on a display of the digital camera shown in FIG. 1A in accordance with an illustrative embodiment of the invention.

FIG. 3C is an illustration of yet another manner of presenting a collection of image templates on a display of the digital camera shown in FIG. 1A in accordance with an illustrative embodiment of the invention.

FIG. 4A is an illustration of using a textual title in live preview mode to indicate that the digital camera shown in FIG. 1A is in an image capture context corresponding to a selected image template in accordance with an illustrative embodiment of the invention.

FIG. 4B is an illustration of using a thumbnail image of an associated sample image in live preview mode to indicate that the digital camera shown in FIG. 1A is in an image capture context corresponding to a selected image template in accordance with an illustrative embodiment of the invention.

FIG. 4C is an illustration of faintly superimposing an associated sample image in live preview mode to indicate that the digital camera shown in FIG. 1A is in an image capture context corresponding to a selected image template in accordance with an illustrative embodiment of the invention.

FIG. 5 is a conceptual diagram showing replacement of certain associated sample images by user images in a collection of image templates in accordance with an illustrative embodiment of the invention.

FIG. 6 is an illustration of textual instructions, on the display of the digital camera shown in FIG. 1A, for capturing a user image in accordance with an illustrative embodiment of the invention.

FIG. 7 is a flowchart of a method of operation of the digital camera shown in FIG. 1A in accordance with an illustrative embodiment of the invention.

FIG. 8 is a flowchart of a method for automatically generating a photo album from the associated sample and/or user images of a collection of image templates in accordance with an illustrative embodiment of the invention.

### DETAILED DESCRIPTION OF THE INVENTION

Guiding a user in the capture of digital images in a digital camera may be improved by providing a collection of image templates in the digital camera, each image template representing a particular shot or class of shots. The templates in the collection may be presented on the display of a digital camera as browseable graphics (browseable in the same way as images stored in the digital camera) or, for example, as a graphical or textual list or menu. Each image template may have a corresponding image capture context in the digital camera. That is, when a particular image template is selected, the digital camera may automatically enter a picture-taking context in which a digital image captured in that context becomes associated with the selected image template. Further, an image template may have an associated sample image that illustrates good photographic technique for a particular shot or class of shots. This associated sample image may optionally be replaced by a digital image captured by the user in the image capture context corresponding to a selected image template. An image template collection may have a theme. For example, a collection of image templates may have a special-event theme such as “Wedding,” “Birthday,” or “Baby Shower.” As a further example, a collection of image templates may have a vacation-destination theme such as “Venetian Tour.” Many other themes are possible, such as car-accident insurance photos, crime scenes, or real estate.

A user may select from among the image templates in a collection in any order. That is, the user is not restricted by a script that imposes a prescribed order on the taking of pictures. Within, for example, a “Wedding” image-template collection, one image template, “Bride Tossing Bouquet,” may correspond to a shot of the bride tossing her bouquet. If the image template includes a sample image, the sample image provides an example, in the digital camera, of a professional shot illustrating good composition, lighting, choice of shutter speed, and other photographic techniques. This associated sample image may optionally be replaced by a digital image captured by the user (“user image”). When a user image becomes associated with an image template in this way, the associated sample image may be deleted entirely (literal replacement) or retained in the digital camera with the option of later reinstatement (virtual replacement). Further, an image template may provide textual or audible instructions in addition to the sample image. The image-template concept may be extended by, for example, creating subcategories within a collection, each subcategory containing one or more image templates. Also, multiple sample images may be associated with a single image template in some embodiments.

Image template collections may support a lucrative market as digital-camera accessories. For example, a tourist visiting London may purchase an image template collection of the important attractions. The user may optionally replace each stock professional photo (associated sample image) with his or her own shot. If the user misses a particular attraction, for example, he or she may elect to use the stock image in a photo album of the trip, much like buying a postcard to make up for a missed or bad shot.

A user may elect to generate automatically, in the digital camera or in an external device such as a personal computer (PC), a photo album containing the sample and/or user images associated with the image-template collection. Such a photo album may, for example, include a particular page layout with a specified border or other embellishment. In the London vacation example, the user may decide to include in the photo album the stock image of Westminster Abbey while using his or her own shots of the other attractions. The balance of this description explains the principles and operation of the invention in more detail.

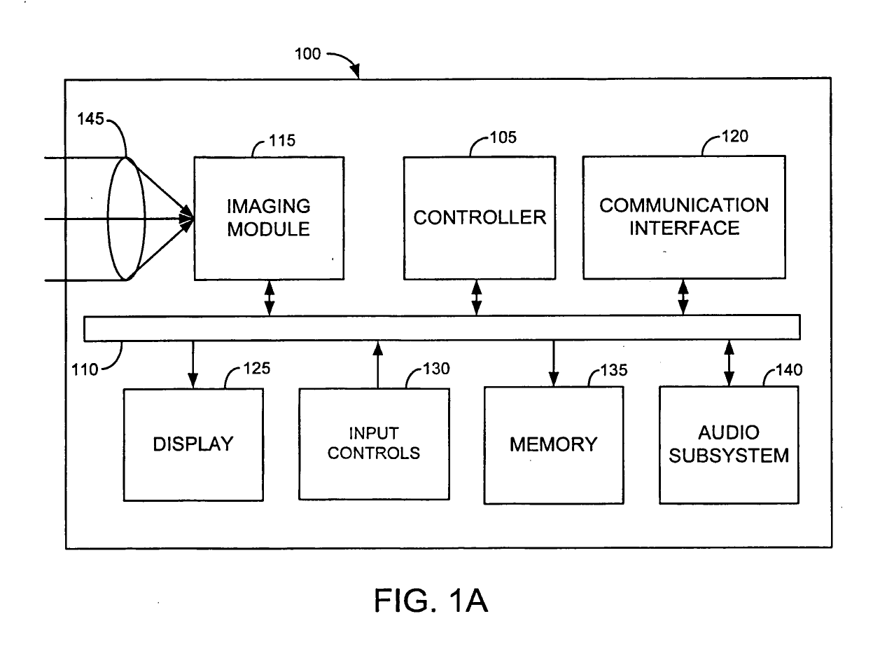

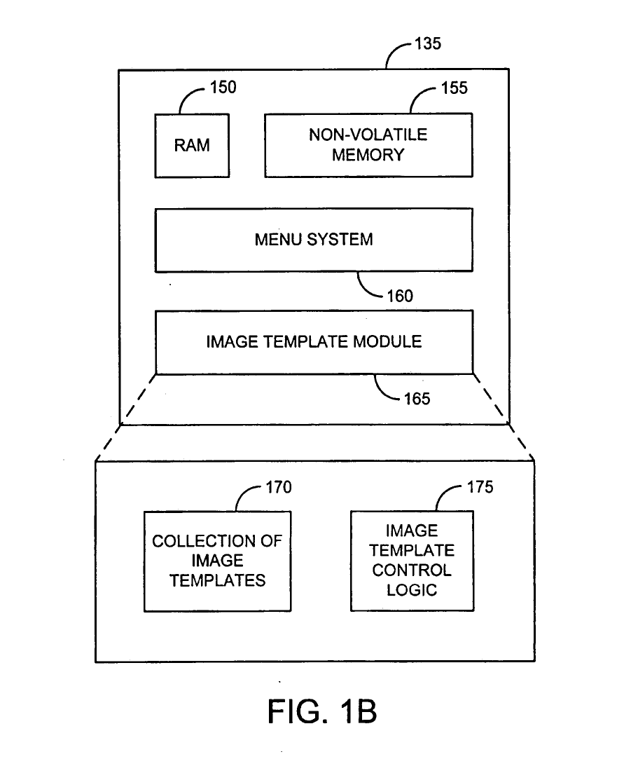

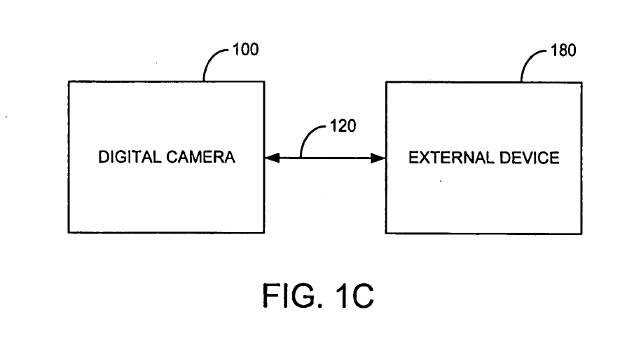

FIG. 1 is a functional block diagram of a digital camera 100 in accordance with an illustrative embodiment of the invention. In FIG. 1A, controller 105 communicates over data bus 110 with imaging module 115, communication interface 120, display 125, input controls 130, memory 135, audio subsystem 140. Optical system 145 produces optical images that are converted to digital images by imaging module 115. Imaging module 115 may comprise an array of photosensors based on charge-coupled-device (CCD) or CMOS technology, an analog-to-digital converter (A/D), a gain control, and a digital signal processor (DSP) (not shown in FIG. 1A). Communication interface 120 may be of the hard-wired variety, such as universal system bus (USB) or firewire (IEEE 1394), or it may be wireless, such as Bluetooth or IEEE 802.11. Input controls 130 may include navigational buttons (e.g., directional-arrow buttons), a menu or “ok” button, a shutter release button, or other controls, physical or virtual, for controlling the operation of digital camera 100. Audio subsystem 140 may comprise circuitry for converting stored digital sound files to analog form and outputting the analog signals to one or more speakers.

FIG. 1B is a high-level diagram of memory 135 in accordance with an illustrative embodiment of the invention. Memory 135 may comprise both random access memory (RAM) 150 and non-volatile memory 155. Non-volatile memory 155 may be of the removable variety. Functionally, memory 135 may also contain, in RAM 150 and/or non-volatile memory 155, program code for a menu system 160 (user interface) that is executed by controller 105. Memory 135 may also include, in RAM 150 and/or non-volatile memory 155, image template module 165. Image template module 165 comprises, functionally, at least one collection of image templates 170 and image template control logic 175. Collection of image templates 170 and image template control logic 175 may be part of a single logical unit (e.g., part of an integrated collection of program code), or, for example, image template control logic 175 may be an application executed by controller 105 that reads a separate collection of image templates 170. Further, image template module 165 may be part of menu system 160, or the functionality of image template module 165 may be provided in some other way. For example, image template module 165 or image template control logic 175 may be a separate software application executed by controller 105. In general, the functionality of menu system 160 and image template module 165 may be implemented in hardware, firmware, software, or any combination thereof.

FIG. 1C is a functional block diagram of the digital camera 100 shown in FIG. 1A in communication with an external device 180 in accordance with an illustrative embodiment of the invention. In FIG. 1C, digital camera 100 communicates with external device 180 via communication interface 120. Communication interface 120 allows a collection of image templates 170 to be downloaded to digital camera 100 from an external device such as a PC. For example, digital camera 100 may download a collection of image templates 170 from the Internet via a Bluetooth connection with a PC linked to the Internet. Alternatively, external device 180 may be a modem or interface card in digital camera 100 that allows digital camera 100 to receive collections of image templates 170 directly from a network. In general, external device 180 is any external device from which digital camera 100 may download a collection of image templates 170, whether the collection of image templates 170 originates with the external device 180 or from a network to which external device 180 is connected.

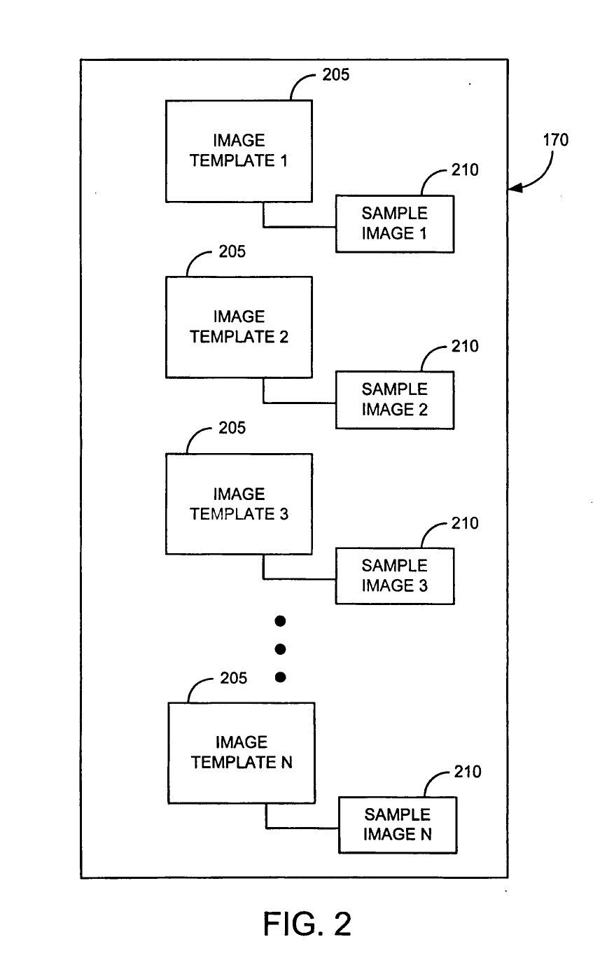

FIG. 2 is a conceptual diagram of a collection of N image templates 170 (“collection”) in accordance with an illustrative embodiment of the invention. Collection 170 comprises at least one image template 205, each of which may have at least one associated sample image 210 (e.g., a stock professional shot of a scene illustrating good photographic technique). Each image template 205 may correspond to a particular shot or class of shots in a collection of related images. That is, collection 170 may have a theme. The theme may be, for example, a special event such as a wedding, birthday, graduation, baby shower, or holiday celebration (e.g., Christmas). In another embodiment, the theme may be a place, such as a travel destination. Many other theme types are possible, all of which are considered to be within the scope of the invention as claimed.

Collection 170 may guide a user in the capture of digital images in digital camera 100 in at least three ways. First, the various shots to which the image templates 205 correspond remind the user of what kinds of shots are typical or expected in particular contexts. Second, the optional sample images 210 provide the user with a tangible example of how to set up a particular shot. Finally, optional textual and/or audible instructions or tips may be provided to guide the user in capturing a user image in connection with a particular image template 205. Since image templates 205 may be selected in any order, the user is not hampered by a script that imposes a rigid picture-taking order.

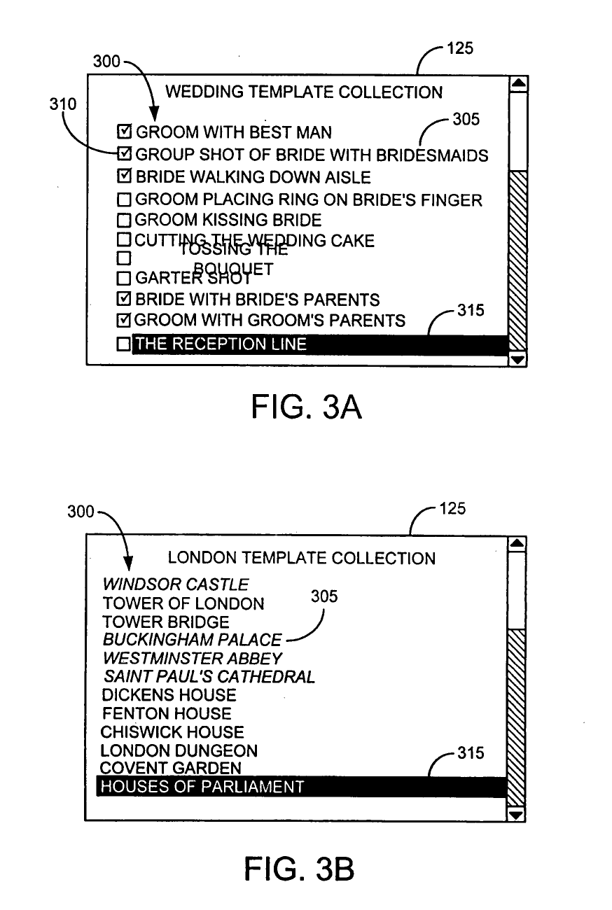

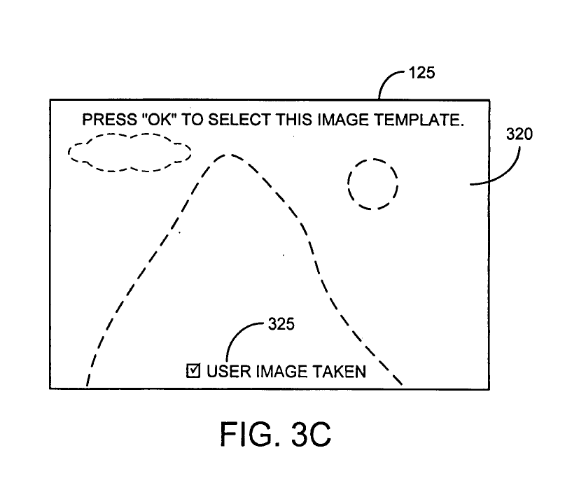

The image templates 205 in a collection 170 may be presented to the user in a variety of ways (see FIGS. 3A-3C for examples). The presentation of a collection to the user on display 125 may be formatted and controlled by, for example, image template control logic 175. Once the user has selected a particular image template 205 using input controls 130, image template control logic 175 may activate a corresponding image capture context in digital camera 100. That is, digital camera 100 may enter a special mode in which image template control logic 175 associates an image captured by digital camera 100 while digital camera 100 is in that image capture context with the selected image template 205 (this associated captured image is referred to above as a “user image”). As explained previously, replacement of an associated sample image 210 by a user image may be literal or virtual.

To aid the user in keeping track of which image templates 205 have associated user images, the presentation of collection 170 to the user on display 125 may provide an indication. FIGS. 3A-3C show three examples of ways in which collection 170 may be presented to the user and such an indication may be provided in accordance with illustrative embodiments of the invention. Many other variations are possible and are considered to be within the scope of the invention as claimed.

In FIG. 3A, a list of image template titles 305 are presented in list 300. A checked check box 310 next to an image template title 305 indicates that the corresponding image template 205 has an associated user image (that the user has taken a picture corresponding to the shot the image template 205 represents). The image templates with which no user image is associated may be indicated by unchecked check boxes 310. Scrollable cursor 315 allows the user to select image templates 205 from list 300 in arbitrary order. Selection of a particular image template 205 may be accomplished by activation of an appropriate input control 130 (e.g., the “ok” button).

In FIG. 3B, list 300 is again presented, but distinct typefaces are used to differentiate between image templates 205 with which a user image has become associated and those with which no user image is associated. In this particular example, an italicized title 305 indicates the corresponding image template 205 has an associated user image. Plain text indicates the corresponding template has no associated user image (although it may nevertheless have an associated sample image 210). This approach may be implemented in many other ways. For example, the image templates 205 with which a user image is associated may be shown in a fainter typeface (e.g., grayed out).

FIG. 3C illustrates presenting image templates 205 in collection 170 as browseable graphics. In this embodiment, each image template is represented by a browseable “placeholder” image 320. The placeholder image represents a particular shot or class of shots and may be an outline or “cartoon-like” in style, as indicated by the dashed lines in FIG. 3C. A user may browse among placeholder images 320 just like any other images stored in digital camera 100. When the user desires to take a shot corresponding to a particular image template 205, that image template 205 may be selected by use of input controls 130. Any associated sample image 210 or textual or audible instructions may then be accessed from a user interface shown on display 125. There are many ways in which indication may be given that an image template has an associated user image. One simple method, text with a check box 325, is illustrated in FIG. 3C. Alternatively, placeholder image 320 may be in outline style or displayed faintly prior to the capture of an associated user image and then become solid/bold after capture of an associated user image. Many other approaches are possible and are considered to be within the scope of the invention as claimed.

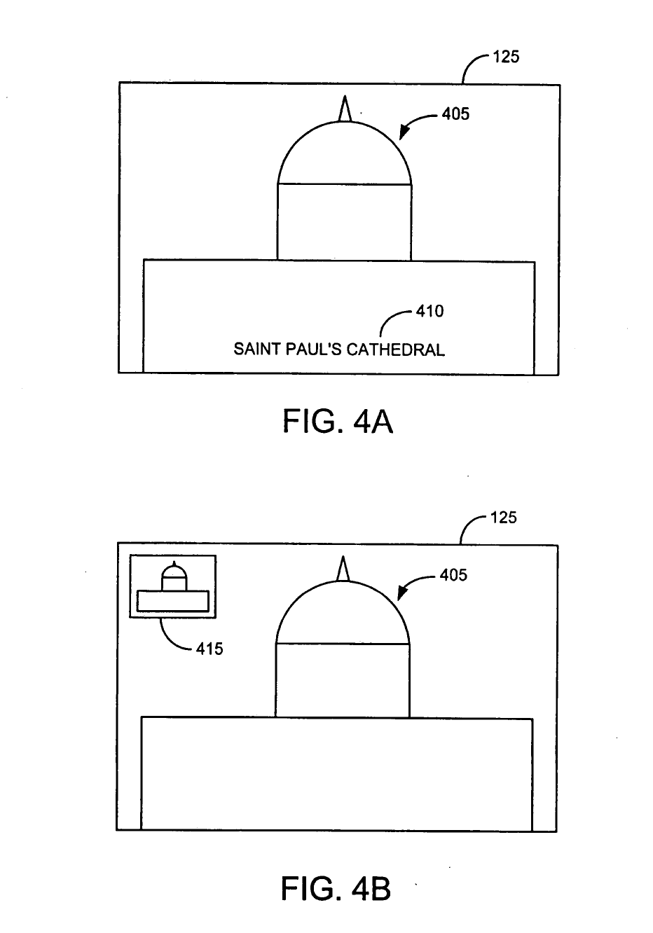

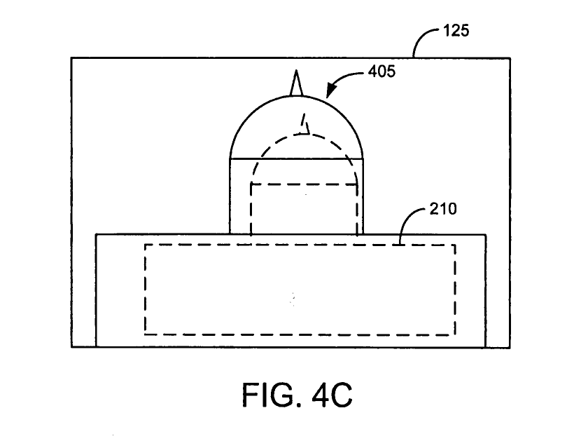

Image template control logic 175 may indicate to the user that digital camera 100 is in the image capture context corresponding to a selected image template 205. FIGS. 4A-4C show three examples of how this may be accomplished. Other variations are possible and are considered to be within the scope of the invention as claimed.

FIG. 4A is an illustration showing a live preview of a scene 405 on display 125 of digital camera 100 in accordance with an illustrative embodiment of the invention. Live preview mode is the real-time view of a scene a digital camera displays before an image is captured. In this example, scene 405 comprises a simplified facsimile of Saint Paul's Cathedral in London. When the user selects the “Saint Paul's Cathedral” image template 205, image template control logic 175 may activate the image capture context corresponding to that image template 205. Image template control logic 175 may also indicate that digital camera 100 is in the corresponding image capture context using text string 410. Such a text string 410 (e.g., corresponding to the title 305 of an image template 205) may be superimposed over the live preview in any suitable portion of display 125. A digital image captured at this point (a user image) may become associated with the selected image template 205, literally or virtually replacing associated sample image 210, if applicable.

FIG. 4B is an illustration showing a live preview of scene 405 on display 125 of digital camera 100 in accordance with another illustrative embodiment of the invention. In this example, a thumbnail image 415 of an associated sample image 210 is superimposed over the live preview to indicate that digital camera 100 is in the image capture context corresponding to the selected image template 205 (“Saint Paul's Cathedral”). Such a thumbnail image, like text string 410, may be opaque or translucent.

FIG. 4C is an illustration showing a live preview of scene 405 on display 125 of digital camera 100 in accordance with yet another illustrative embodiment of the invention. In this example, a sample image 210 is faintly (translucently) superimposed over the live preview. The translucent sample image 210 may be full sized in this embodiment.

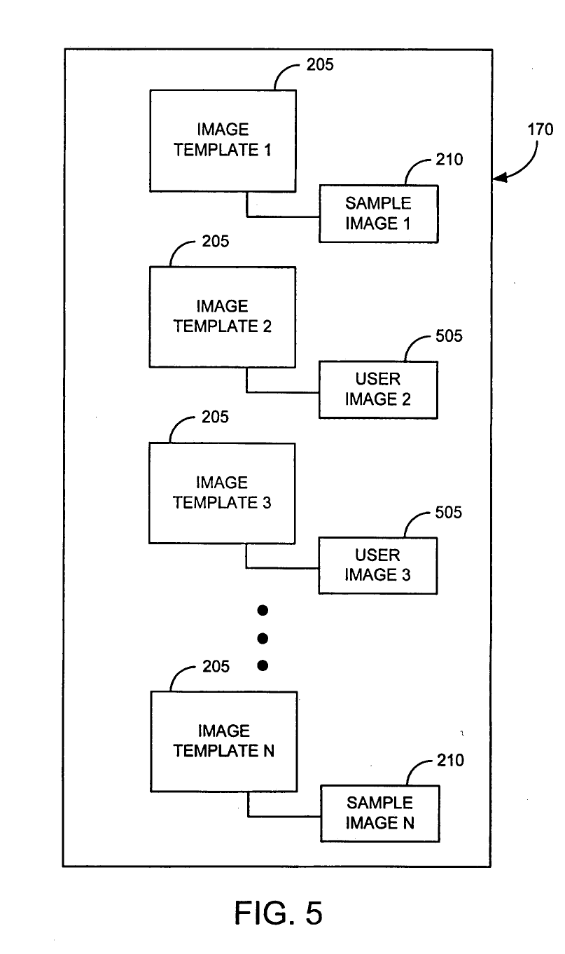

FIG. 5 is a conceptual diagram similar to FIG. 2 showing replacement of certain associated sample images 210 by user images 505 in a collection of image templates 170 in accordance with an illustrative embodiment of the invention. In the state shown in FIG. 5, collection 170 comprises a mixture of the original sample images 210 and user images 505. In this example, sample images 2 and 3 (210) have been replaced (literally or virtually) by user images 2 and 3 (505).

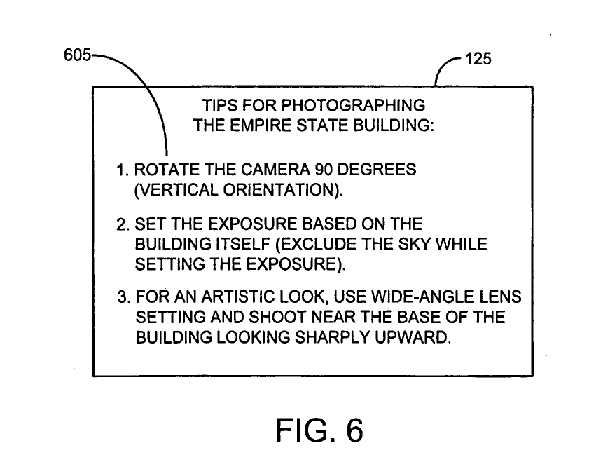

FIG. 6 is an illustration of textual instructions 605, on display 125 of digital camera 100, for capturing a user image 505 to be associated with a selected image template 210 in accordance with an illustrative embodiment of the invention. Such textual instructions may, instead of or in addition to a sample image 210, be associated with an image template 205. The simplified example in FIG. 6 shows some basic tips for photographing a tall building such as the Empire State Building. Textual instructions 605 may be superimposed over the live preview in the corresponding image capture context (see FIGS. 4A-4C), or they may be displayed on a separate screen accessible, for example, from a menu option once the associated image template 205 has been selected.

As alternative to the textual approach illustrated in FIG. 6, audible instructions (e.g., from a compressed digital audio file stored on digital camera 100 and linked to collection 170) may instead be provided. In such an embodiment, audio subsystem 140, under control of image template control logic 175, may output audible instructions while digital camera 100 is in the image capture context corresponding to a selected image template 205. The audible instructions may be invoked, for example, by selection of a menu option or the activation of a special input control 130 on digital camera 100.

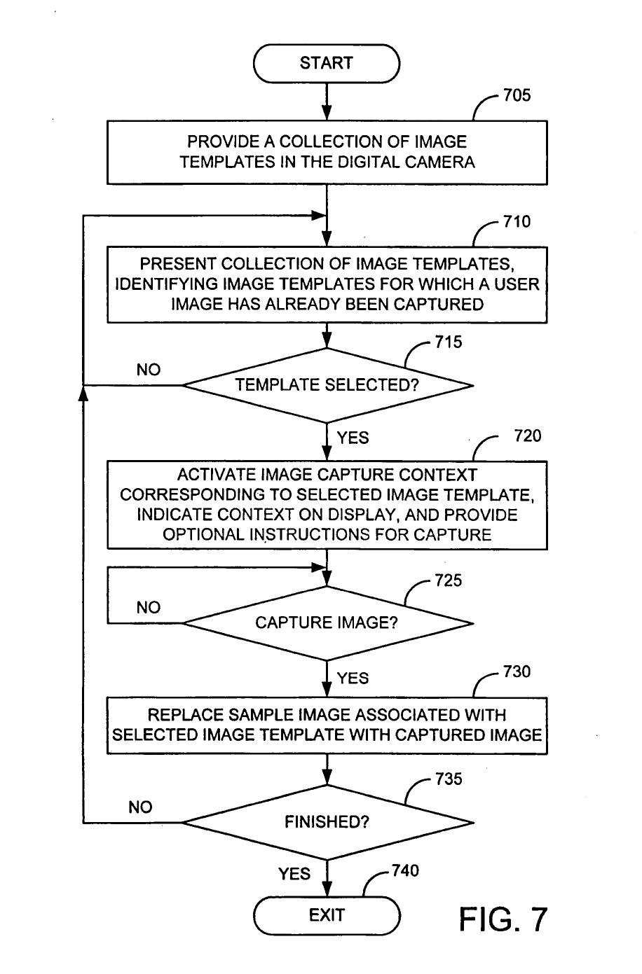

FIG. 7 is a flowchart of a method of operation of digital camera 100 in accordance with an illustrative embodiment of the invention. At 705, a collection 170 of image templates 205 (see FIG. 2) is provided in digital camera 100. Collection 170 may be stored in digital camera 100 during its manufacture, or it may be downloaded to digital camera 100, as explained in connection with FIG. 1C. At 710, image template control logic 175 may present collection 170 on display 125 of digital camera 100. Which image templates 205 already have an associated user image 505 may also be indicated on display 125 at this point. Image template control logic 175 may be activated by, for example, selection of a menu option from menu system 160 or the launching of an application. Selection of an image template 205 at 715 may cause image template control logic 175 to activate the image capture context corresponding to the selected image template 205 at 720. Optionally, image template control logic 175 may also indicate the active image capture context on display 125 and provide an option to access textual or audible instructions 605 for capturing a user image 505 in the image capture context corresponding to the selected image template 205. If digital camera 100 receives an input (130) from the user and a digital image is consequently captured at 725, image template control logic 175 may associate the captured digital image (user image 505) with the selected image template 205, literally or virtually replacing associated sample image 210 at 730, if a sample image 210 was present. If more user images 505 are to be taken at 735, control returns to 710. Otherwise, the process terminates at 740.

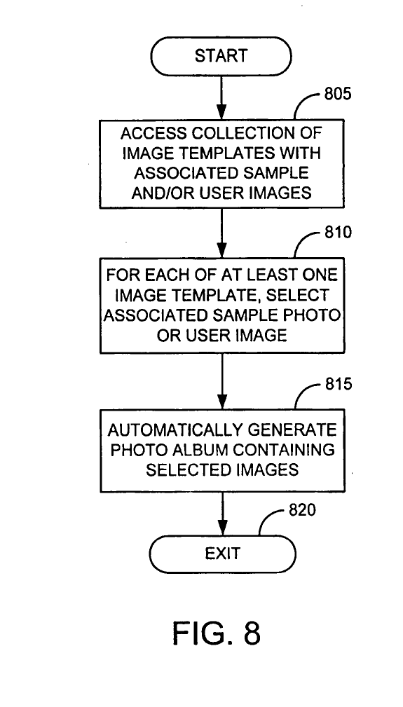

FIG. 8 is a flowchart of a method for automatically generating a photo album from the associated sample and/or user images (210 and 505, respectively) of a collection of image templates 170 in accordance with an illustrative embodiment of the invention. At 805, image template control logic 175 accesses collection 170, which may contain a mixture of associated sample and user images (210 and 505, respectively), as shown in FIG. 5. At 810, an associated sample image 210 or an associated user image 505 is selected for at least one image template 205 in collection 170. At 815, a photo album containing the selected images is automatically created. The album thus generated may be based on default or user-selected preferences for paper size, border, layout, etc. The process terminates at 820. Steps 805, 810, and 815 may be performed in digital camera 100 (especially if digital camera 100 can be directly connected to a printer) or in an external device 180 such as a PC.

In another illustrative embodiment, the invention may be implemented as a computer-readable storage medium containing data and/or program code for execution in digital camera 100. Such a computer-readable storage medium may comprise, for example, an optical disc, magnetic disc, solid-state memory card (e.g., secure-digital or multi-media card), or other removable storage compatible with digital camera 100. The computer-readable storage medium may comprise a first code segment comprising a collection of image templates 170, each image template 205 having a corresponding image capture context in digital camera 100. Optionally, the computer-readable storage medium may include a second code segment corresponding to image template control logic 175 described above. As in the other embodiments described above, sample images 210 and textual or audible instructions for picture taking may also be included in collection 170.

The foregoing description of the present invention has been presented for the purposes of illustration and description. It is not intended to be exhaustive or to limit the invention to the precise form disclosed, and other modifications and variations may be possible in light of the above teachings. The embodiments were chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

1-44. (canceled)

45. A digital camera comprising:
a processor;
a computer readable memory accessible by the processor;
a collection of image templates stored in the computer readable memory and accessible by a user of the digital camera, and wherein the collection of image templates comprises a plurality of exemplary images related to a theme; and wherein:
upon a selection by the user of a specific exemplary image from the plurality of exemplary images, and the capture of an image by the user relating to the specific exemplary image, the processor is configured to store the captured image as a stored image, and to identify the specific exemplary image with the stored image.

46. The digital camera of claim 45, and wherein the theme relates to one of a special event or a place.

47. A digital camera comprising:
a processor;
a computer readable memory accessible by the processor;
a collection of image templates stored in the computer readable memory and accessible by a user of the digital camera, and wherein the collection of image templates comprises a list of exemplary images related to a theme; and wherein:
upon a selection by the user of a specific exemplary image from the list of exemplary images, and the capture of an image by the user relating to the specific exemplary image, the processor is configured to store the captured image as a stored image, and to identify the specific exemplary image with the stored image.

49. The digital camera of claim 48, and wherein the theme relates to one of a special event or a place.

50. A method of guiding a user in selecting a digital image to be captured by the user of a digital camera, comprising:
providing, within a user-accessible computer readable memory with the digital camera, a collection of image templates comprising exemplary images to be captured by the user, and wherein the collection of image templates comprises exemplary images related to at least one of a special event or a place;
upon a selection by the user of a specific exemplary image from the plurality of exemplary images, and the capture of an image by the user relating to the specific exemplary image, storing the captured image as a stored image; and
identifying the specific exemplary image with the stored image.

51. The method of claim 50, and wherein the theme relates to one of a special event or a place.

52. A method of guiding a user in selecting a digital image to be captured by the user of a digital camera, comprising:
providing, within a user-accessible computer readable memory with the digital camera, a collection of image templates comprising a list of exemplary images to be captured by the user, and wherein the collection of image templates comprises a list of exemplary images related to at least one of a special event or a place;
upon a selection by the user of a specific exemplary image from the list of exemplary images, and the capture of an image by the user relating to the specific exemplary image, storing the captured image as a stored image; and
identifying the specific exemplary image with the stored image.

53. The method of claim 52, and wherein the theme relates to one of a special event or a place.
